(19) United States
(12) Patent Application Publication
(10) Pub. No.: US 2008/0123338 A1
(43) Pub. Date: May 29, 2008

(54) Lighting device

(75) Inventor: Haruo Kokado, Himeji-shi (JP)

Correspondence Address: Kazunao Kubotera;TAKEUCHI & KUBOTERA, LLP, Suite 202, 200 Daingerfield Road, Alexandria, VA, 22314, US

(73) Assignee: Phoenix Electric Co., Ltd.

(21) Appl. No.: 11/979,289

(22) Filed: Nov. 1, 2007

(30) Foreign Application Priority Data
Nov. 27, 2006 (JP) JP2006-318666

(51) Int. Cl. F21V 14/04; F21V 7/00

(52) U.S. Cl. 362/283; 362/282; 362/296; 362/297

(57) ABSTRACT

A lighting device according to this invention includes: a discharge lamp having an arc length of 3 mm or less; a reflector reflecting light emitted from the discharge lamp in a predetermined direction; and a reflecting device having a reflecting plate for reflecting the light reflected by the reflector toward a subject to be illuminated, the reflecting device being placed apart from the discharge lamp, the reflecting plate has an antifouling layer including a photocatalyst.

### BACKGROUND OF THE INVENTION

1. Field of the Invention

The present invention relates to a lighting device configured to condense collect light emitted from a light source to be reflected by a reflector and illuminate a subject with the condensed light to be further reflected by a reflecting plate.

2. Description of the Related Art

A pole lamp, in which a light source is attached to an upper side of a pole, has been widely used as an outdoor lighting device such as a streetlamp or a garden lamp. Since the light source is positioned at such a high place that an operator cannot reach, it is inconvenient for maintenance and inspection of the light source.

In view of such the inconvenience, various lighting devices which allow maintenance and inspection of the light source to be easy have been developed. One such lighting device is disclosed in patent document 1 (Refer to Japanese Patent Publication No. 2002-260410). The lighting device according to patent document 1 includes a light source attached to a intermediate part of the height direction of a pole and a reflecting plate mounted on an upper end of the pole for reflecting light from the light source so as to illuminate a subject.

With the conventional lighting device according to patent document 1, maintenance and inspection of the light source attached to the intermediate portion of the height direction of the pole can be easy. However, in cases where dirt or soil is deposited on the reflecting plate mounted on the upper end of the pole, it is difficult to wash out the deposited dirt or soil. For this reason, the conventional lighting device has a problem that the reflection efficiency of the reflecting plate lowers gradually as dirt or soil accumulates on the reflecting plate and, hence, the amount of light illuminating the subject decreases.

It is an object of the present invention, therefore, to provide a lighting device which allows maintenance and inspection of its light source to be easy while keeping the reflection efficiency of its reflecting plate constant for a long time.

### SUMMARY OF THE INVENTION

A first aspect in accordance with the present invention provides a lighting device comprising: a discharge lamp, having an arc length of 3 mm or less; a reflector, reflecting light emitted from the discharge lamp in a predetermined direction; and a reflecting device having a reflecting plate for reflecting the light reflected by the reflector toward a subject to be illuminated, wherein the reflecting device is placed apart from the discharge lamp, the reflecting plate has an antifouling layer including a photocatalyst.

The lighting device according to the first aspect, in which the reflecting device and the discharge lamp are placed apart from each other, allows the discharge lamp and the reflecting device to be placed and maintenance and inspection of the discharge lamp to be easy and the lighting angle at which light illuminates the subject to be accurate.

What is more, since the arc length of the discharge lamp is 3 mm or less, the optical paths of light emitted from the discharge lamp are not diverged undesirably and, hence, light can be condensed at the reflecting plate without waste. Specifically, if the arc length of the discharge lamp is larger than 3 mm, the optical path of light emitted from one end of arc 38 (see FIG. 3) and that of light emitted from the other end of arc 38 are largely diverged from each other and, hence, light, as a whole, has an undesirably diverged or widened optical path. In contrast, with a short arc length (3 mm or less) according to the present invention, the optical path divergence can be made small and, hence, the divergence of the optical paths of whole light can be small. Thus, the rate of light condensation at the reflecting plate 20 can be increased.

Further, since the reflecting plate 20 has a antifouling layer including the photocatalyst, when light emitted from the discharge lamp becomes incident on the reflecting plate, the dirt or soil on the reflecting plate is decomposed by the cleanup action of the photocatalyst.

According to a second aspect of the present invention, the reflecting plate of the reflecting device comprises a plurality of the reflecting plates for reflecting the light in different directions.

The feature according to the second aspect makes it possible to reflect the light in different directions by means of the plurality of the reflecting plates. Since the present invention can increase the rate of light condensation at the reflecting plate as described above, a sufficient amount of light can be ensured in each direction notwithstanding light divided into different directions.

According to a third aspect of the present invention, the reflecting device has at least one reflecting plate having a plurality of reflecting surfaces for reflecting the light in different directions.

The feature according to the third aspect of the present invention makes it possible to reflect the light in different directions by the plurality of the reflecting surfaces.

According to a fourth aspect of the present invention, the reflecting device comprises a variable angle mechanism for varying a lighting angle at which the reflecting plate is directed.

The feature according to the fourth aspect of the present invention makes it possible to vary the lighting angle appropriately. Varying the lighting angle is operated manually or automatically with a servomotor or the like.

With the light device according to the present invention in which the reflecting device and the discharge lamp are placed apart from each other, even when the reflecting device is positioned relatively high, the discharge lamp can be positioned at a relatively low place which allows maintenance and inspection of the discharge lamp to be easy. Since the arc length of the discharge lamp is 3 mm or less, even when the optical path length from the discharge lamp to the reflecting device becomes relatively long, it is possible to reduce a waste of light, thereby to ensure a sufficient amount of light for the subject to be illuminated.

Further, since the reflecting plate forming the reflecting device exhibits a self-cleanup action by the photocatalyst, it is possible to suppress deposition of dirt or soil on the reflecting plate even when the reflecting device is positioned relatively high, thereby to keep the reflection efficiency of the reflecting plate constant for a long time.

The foregoing and other objects, features and attendant advantages of the present invention will become more apparent from the reading of the following detailed description of the invention in conjunction with the accompanying drawings.

### BRIEF DESCRIPTION OF THE DRAWINGS

FIG. 1 is a schematic view showing a lighting device;

FIG. 2 is a sectional view showing a discharge lamp and a reflector;

FIG. 3 is a schematic view illustrating optical path deviation;

FIG. 4 is a graph plotting a wavelength distribution of light emitted from a discharge lamp;

FIG. 5 is a perspective view showing a reflecting device;

FIG. 6 is a perspective view showing another reflecting device (having three reflecting plates);

FIG. 7 is a front view showing yet another reflecting device (having two reflecting plates, one of which has four reflecting surfaces);

FIG. 8 is a schematic view showing another lighting device;

FIG. 9 is a schematic view showing yet another lighting device; and

FIG. 10 is a schematic view showing yet another lighting device.

### DETAILED DESCRIPTION OF THE PREFERRED EMBODIMENTS

Referring to figures, there is shown a preferred embodiment of a lighting device of the present invention.

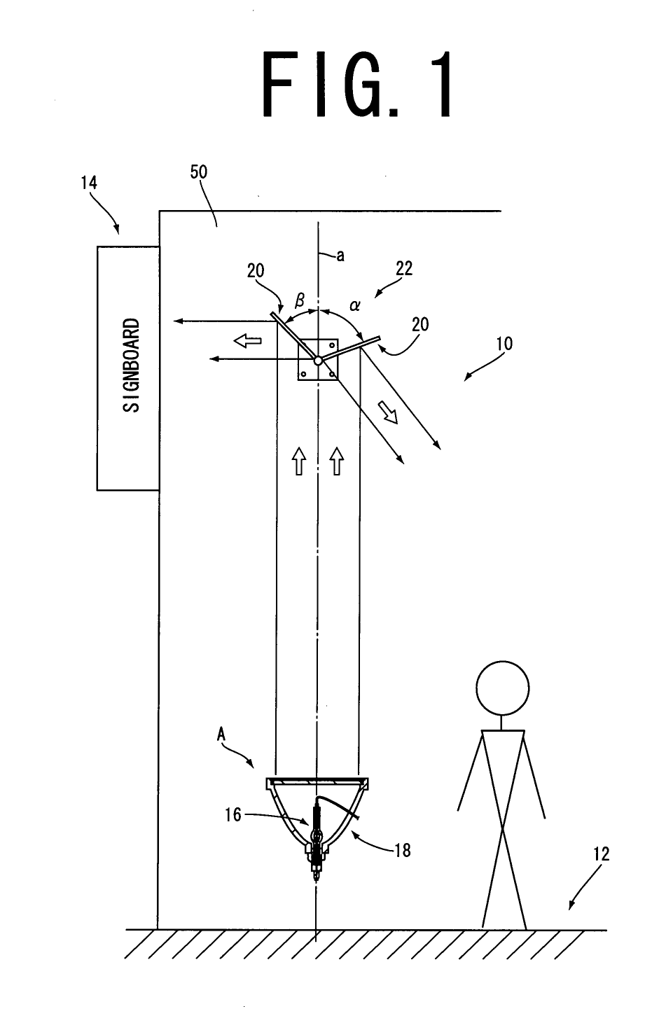

FIG. 1 shows a lighting device 10. The lighting device 10 has both the function of an outdoor lamp for illuminating a street 12 and the function of signboard lighting for illuminating a signboard 14. The lighting device 10 includes a discharge lamp 16 serving as a light source, a reflector 18 for reflecting light emitted from the discharge lamp 16 in a predetermined direction, and a reflecting device 22 having reflecting plates 20 for further reflecting light reflected by the reflector 18 toward the subjects to be illuminated (i.e., street 12 and signboard 14), respectively.

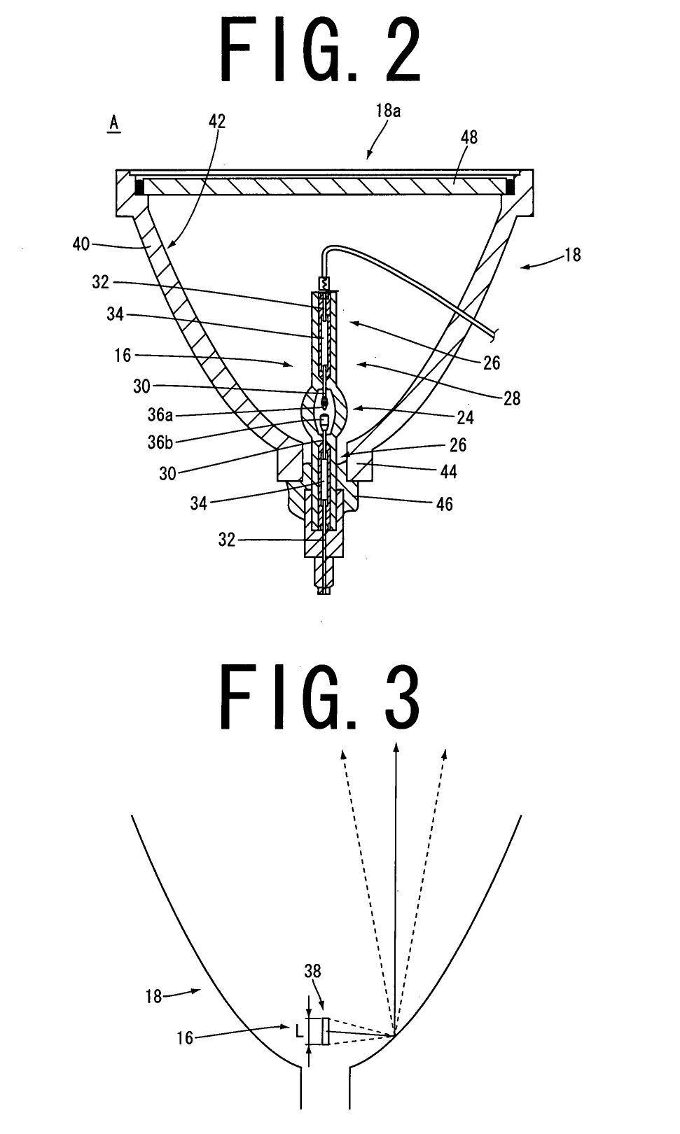

As shown in FIG. 2, the discharge lamp 16 includes a tube 28 of quartz glass comprising a spherical light-emitting portion 24 and rod-shaped seal portions 26 extending from both ends of the light-emitting portion 24. Within each of the seal portions 26 of the tube 28, there are provided an electrode pin 30 having one end protruding into the light-emitting portion 24, a lead pin 32 having one end protruding exteriorly of the seal portion 26, and a molybdenum foil 34 electrically interconnecting the other end of the electrode pin 30 and the other end of the lead pin 32. The ends of the respective electrode pins 30 protruding into the light-emitting portion 24 are each provided with a respective one of electrodes 36a and 36b. The electrodes 36a and 36b are made from a high-melting-point metal such as tungsten. Within the light-emitting portion 24, there are encapsulated high pressure mercury at 0.15 mg/mm³ or more, a rare gas such as argon, and a halogen such as iodine, bromine, chlorine, or fluorine.

In the lighting device 10, to condense the light at the reflecting plates 20 of the reflecting device 22 efficiently by allowing the light emitted from the discharge lamp 16 to be reflected by the reflector 18, divergence of the optical path of light need be suppressed. If a discharge lamp has a relatively large arc length L, the optical path of light emitted from one end of arc 38 and that of light emitted from the other end of arc 38 are diverged from each other largely as represented by broken line in FIG. 3 and, hence, light, as a whole, has an undesirably diverged or widened optical path. In order to avoid this inconvenience, the present embodiment shortens the arc length L of the discharge lamp 16 to 3 mm or less thereby making the optical path deviation relatively small. Thus, the divergence of the optical path of whole light can be suppressed. And, the rate of light condensation at the reflecting plate 20 can be increased.

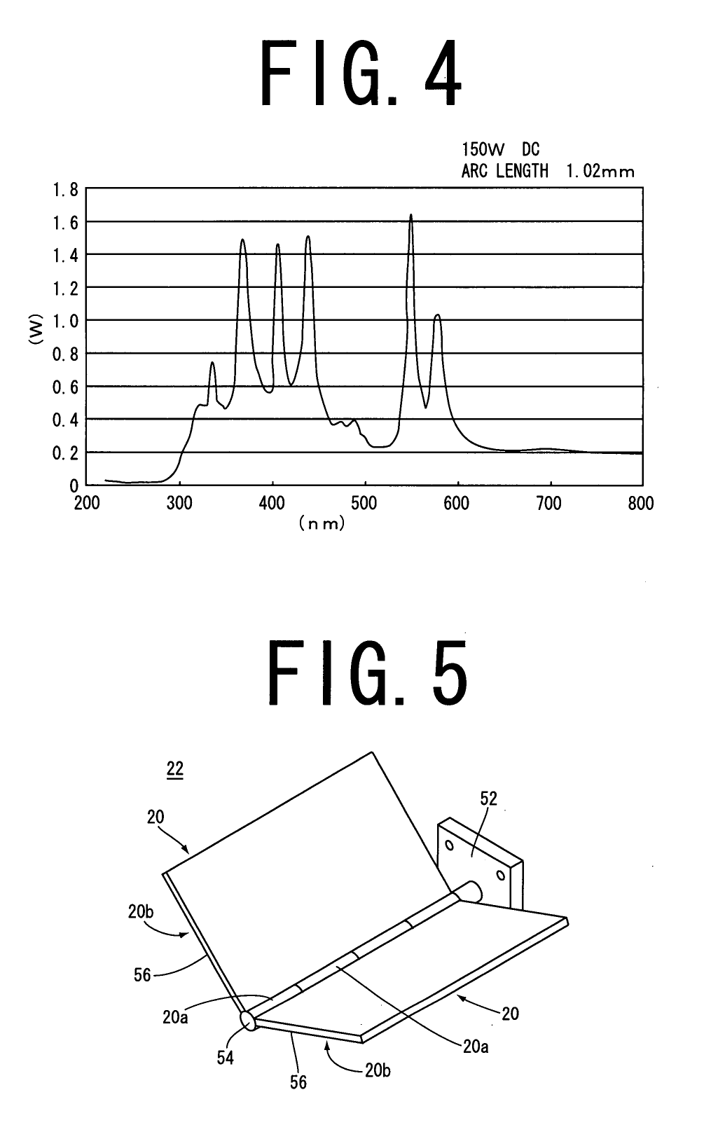

An antifouling layer 56 is formed over the reflecting plates 20 of the lighting device 10. For a self-cleanup action (to be described later), it is preferable that ultraviolet rays having wavelengths ranging from 300 to 400 nm are included within the light emitted from the discharge lamp 16. For this reason, the discharge lamp 16 in the present embodiment emits the light including ultraviolet rays having wavelengths ranging from 300 to 400 nm, as shown in FIG. 4.

The reflector 18 (see FIG. 2) reflects the light emitted from the discharge lamp 16 toward the two reflecting plates 20. The reflector 18 has a reflector body 40 in the form of a paraboloid of revolution, the reflector body 40 comprising a metal such as aluminum. The reflector body 40 has an internal surface formed with a reflecting mirror surface 42. A cylindrical lamp receptacle 44 for receiving one seal portion 26 of the discharge lamp 16 is formed in the center of the reflector body 40.

The material of the reflector body 40 can be used borosilicate glass or the like instead of metal. The reflector body 40 can be shaped into a semicircular surface, an ellipsoid surface or the like instead of the paraboloid. The shape of an opening portion 18a of the reflector 18 can be shaped any desired shape, such as a circular, elliptic or quadrangular without any particular limitation. However, a paraboloid is preferable for the shape of the reflector body 40, because the reflector body 40 formed by paraboloid shape can make the light parallel beam.

In attaching the discharge lamp 16 to the reflector 18, one seal portion 26 of the discharge lamp 16 is inserted into the lamp receptacle 44 and fixed therewith by means of cement 46. Thereafter, the opening portion 18a of the reflector 18 is fitted with a flat cover 48 made from a translucent material such as borosilicate glass.

The reflecting device 22 illuminates the subject (the street 12 and the signboard 14) by reflecting the light from the reflector 18. And the reflecting device 22 is comprised a fitting member 52 to be fitted on a wall surface of a building 50 (see FIG. 1) or the like and the two reflecting plates 20 pivotally mounted about a pivot 54 on the fitting member 52. The two reflecting plates 20 and the pivot 54 comprise a hinge.

Each of the reflecting plates 20 has a bearing 20a pivotally supported on the pivot 54. Each reflecting plate 20 has a reflecting surface 20b (for reflecting light) formed with the antifouling layer 56 including a photocatalyst. Each reflecting plate 20 may have a flat plate shape as in the present embodiment or other shape such as a curved plate shape or a spherical shape without any limitation.

In the reflecting device 22, each reflection plate 20 is prevented from pivoting undesirably by its own weight by a predetermined friction between the pivot 54 and the bearing 20a. However, each reflecting plate 20 can be pivoted by an external force, so that the lighting angle α or β (see FIG. 1) thereof is varied. That is, the pivot 54 and the bearing 20a are cooperated to work as a variable angle mechanism for varying the lighting angle at which each of the reflecting plates 20 is directed. In addition, a stopper for limiting the pivotal movement of each reflecting plate 20 can be provided between the pivot 54 and the bearing 20a.

The antifouling layer 56 decomposes dirt or soil deposited on the reflecting surface 20b by the cleanup action of the photocatalyst included therein. The antifouling layer 56 is a thin film including titanium oxide (TiO2) as the photocatalyst. And the antifouling layer 56 is formed over the reflecting surface 20b of each reflecting plate 20 by a sol-gel method, vacuum deposition, ion plating, CVD, sputtering or a like process. Since titanium oxide (TiO2) can be used as a white pigment, a paint including titanium oxide (TiO2) is preferably used when the reflecting surface 20b need be coated white.

The cleanup action, which has received attention recently, is based on the following principle. When the photocatalyst receives the light including ultraviolet rays within a predetermined wavelength range, electrons in the photocatalyst are excited by the energy of light and moved into air, so that positive holes are generated. Such positive holes oxidize moisture to produce an active oxygen species having a potent oxidizing power. When an organic dirt or soil is deposited near such the active oxygen species, the organic dirt or soil is deprived of electrons (i.e., oxidized) and then decomposed into carbon dioxide and water finally. In this way, the organic dirt or soil is removed.

Known photocatalyst exhibiting such a cleanup action are such metal oxides as titanium oxide (TiO2), zinc oxide (ZnO) and tungsten oxide (WO3). Among these metal oxides, titanium oxide (TiO2) is the most preferable because titanium oxide has a high potent oxidizing power and stable physical properties and is inexpensive. For this reason, the present embodiment preferably uses titanium oxide (TiO2) as the photocatalyst to be included in the antifouling layer 56.

Receiving ultraviolet rays having wavelengths within the predetermined range on the photocatalyst makes the cleanup action of the photocatalyst. It is known that the ultraviolet rays having wavelengths ranging from 300 to 400 nm make the cleanup action of titanium oxide used as the photocatalyst. For this reason, the discharge lamp 16 used in the present embodiment is preferably a discharge lamp emitting light including ultraviolet rays having wavelengths ranging from 300 to 400 nm (see FIG. 4).

In installing the lighting device 10 (see FIG. 1), a light source unit A comprising the discharge lamp 16 and the reflector 18 is placed at a relatively low place which allows maintenance and inspection of the light source unit A to be easy, while the reflecting device 22 is placed at a relatively high place such as a wall surface of the building 50. At that time, the light source unit A and/or the reflecting device 22 is adjusted so that an optical axis a of the light to be emitted from the light source unit A passes through the center of the pivot 54 of the reflecting device 22. In the reflecting device 22, the lighting angle α which one reflecting plate 20 forms with the optical axis a is adjusted so that the street 12 is illuminated with light reflected by that reflecting plate 20, while at the same time the lighting angle β which the other reflecting plate 20 forms with the optical axis a adjusted so that the signboard 14 is illuminated with light reflected by that reflecting plate 20.

When a lighting switch (not shown) of the lighting device 10 is turned on, an arc is generated between the electrodes 36a and 36b, the discharge lamp 16 becomes a point light source having an arc length of 3 mm or less. And the light generated between the electrodes 36a and 36b is emitted from the discharge lamp 16 and then reflected by the reflector 18 to reach the reflecting device 22. Since the two reflecting plates 20 of the reflecting device 22 are inclined at different lighting angles α and β, light incident on the two reflecting plates 20 is reflected in directions corresponding to the respective inclination lighting angles α and β to illuminate the different subjects (street 12 and signboard 14).

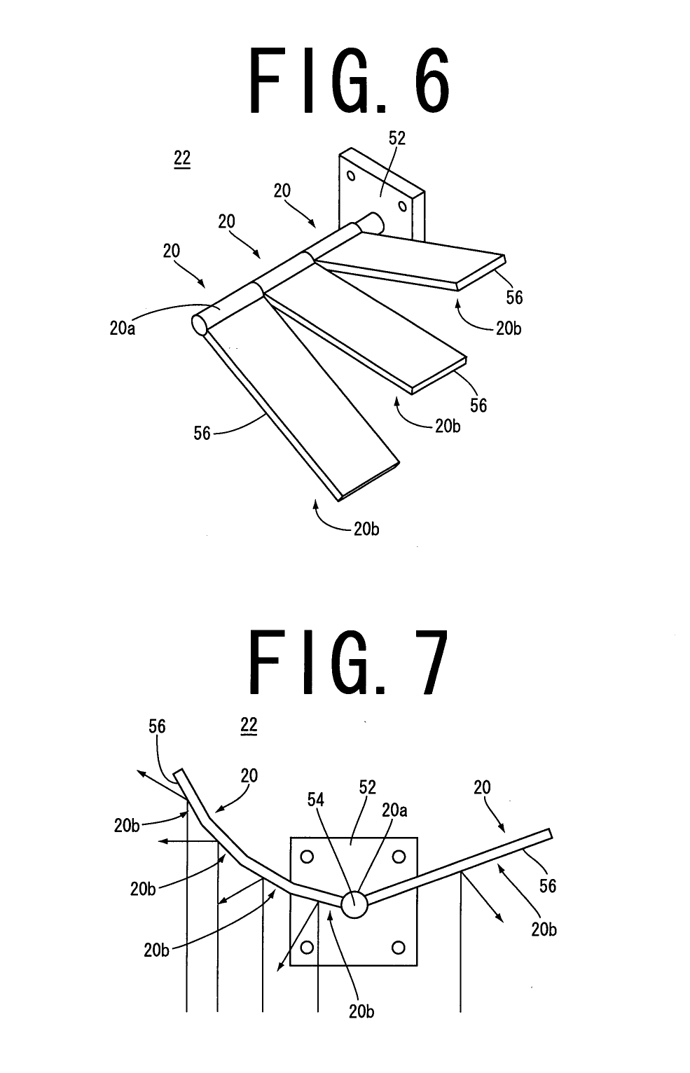

While the foregoing embodiment uses the reflecting device 22 having the two reflecting plates 20, the number of reflecting plates 20 can be varied appropriately. For example, the number of reflecting plates 20 can be three as shown in FIG. 6, or one, four or more than four. At least one reflecting plate 20 can be formed with a plurality of reflecting surfaces 20b having different lighting angles of reflection (see FIG. 7).

The lighting angle of each reflection plate 20 can be adjusted automatically by means of a servomotor or the like. In this case, the variable lighting angle mechanism comprises the pivot 54, bearing 20a and servomotor or the like.

The subjects to be illuminated by the lighting device 10 can be changed to other subjects. The lighting device 10 can illuminate only one of the street 12 or the signboard 14. Also the lighting device 10 can illuminate at least any one of subjects including a street, signboard, garden, building, parking area and automobiles parked in such a parking area.

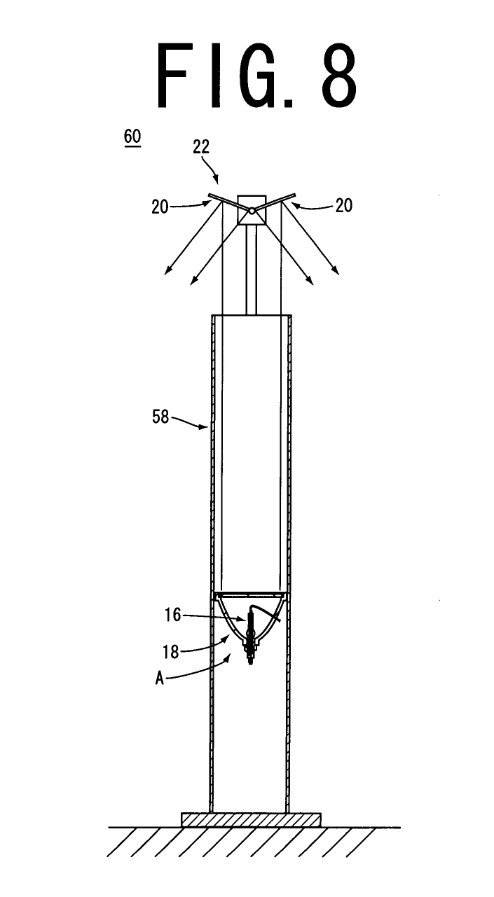

While the reflecting device 22 of the foregoing embodiment is fitted on the wall surface of the building 50 (see FIG. 1) or the like, as shown in FIG. 8-10, the reflecting device 22 can be fitted either on an upper side of a pole 58 standing upright on the ground or the like or on such a structure as a bridge, elevated railroad or the like (not shown).

A lighting device 60 shown in FIG. 8 has the light source unit A (comprising the discharge lamp 16 and the reflector 18) placed in a intermediate part of the height direction of the pole 58, and the reflecting device 22 placed in an upper end of the pole 58. With this lighting device 60, light emitted from the light source unit A is reflected by the reflecting plates 20 of the reflecting device 22 to illuminate a subject such as a street, garden, or parking lot.

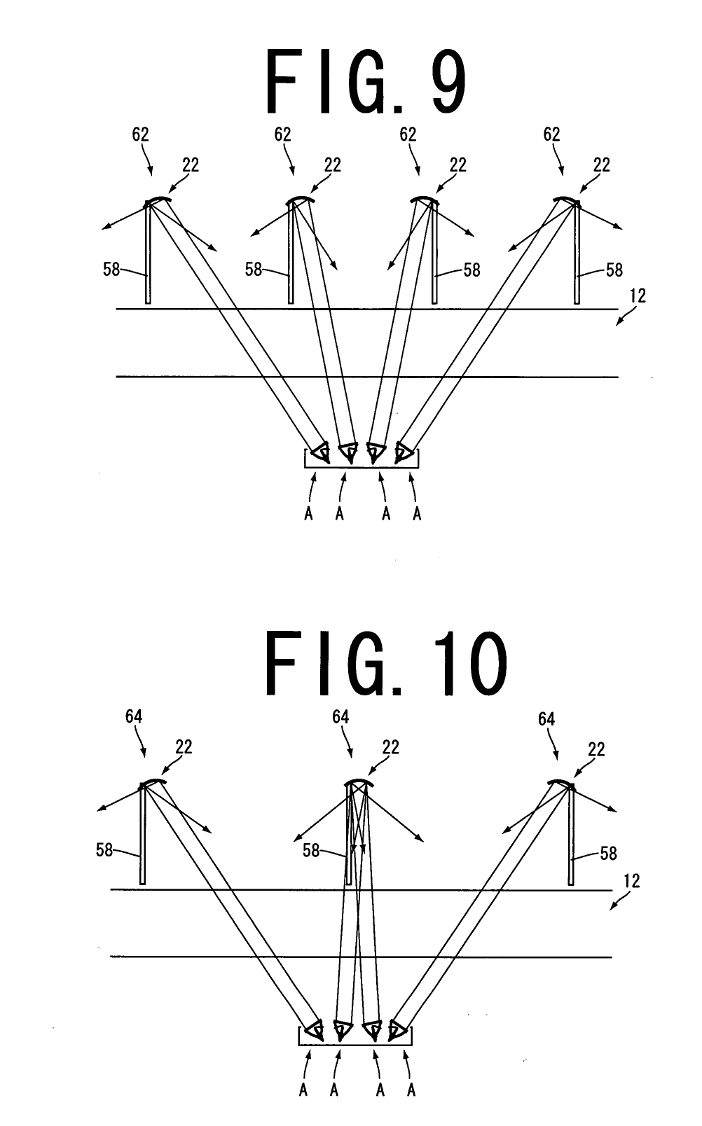

A lighting device 62 shown in FIG. 9 includes a plurality of poles 58 arranged along a subject to be illuminated (for example, the street 12 in FIG. 9), reflecting devices 22 each placed in a respective one of the poles 58 at an upper end thereof, and a plurality of light source units A (each comprising the discharge lamp 16 and the reflector 18) concentrically arranged at one point placed apart from the poles 58, the light source units A being associated with respective of the reflecting devices 22. Since the plurality of light source units A of the lighting device 62 associated with the plurality of reflecting devices 22 are concentrically arranged at one point, maintenance and inspection of the light source units A can be easy.

A lighting device 64 shown in FIG. 10 is a variation of the lighting device 62 shown in FIG. 9, wherein at least one of the reflecting devices 22 is associated with a plurality of light source units A each comprising the discharge lamp 16 and the reflector 18. Accordingly, that reflecting device 22 which is associated with the plurality of light source units A can illuminate the subject particularly brightly. The other light source units A each associated with one reflecting device 22 need not necessarily be turned on at the same time. These light source units A may be turned on selectively in accordance with hours or seasons.

The foregoing embodiments are illustrative in all points and should not be construed to limit the present invention. The scope of the present invention is defined not by the foregoing embodiments but by the following claims. Further, the scope of the present invention is intended to include all modifications within the meanings and scopes of claims and equivalents.

The disclosure of Japanese Patent Application No. 2006-318666 filed Nov. 27, 2006 including specification, drawings and claims is incorporated herein by reference in its entirety.

What is claimed is:

1. A lighting device comprising:
a discharge lamp, having an arc length of 3 mm or less;
a reflector, reflecting light emitted from the discharge lamp in a predetermined direction; and
a reflecting device, having a reflecting plate for reflecting the light reflected by the reflector toward a subject to be illuminated,
wherein the reflecting device is placed apart from the discharge lamp,
the reflecting plate has an antifouling layer including a photocatalyst.

2. The lighting device according to claim 1, wherein the reflecting device comprises a plurality of the reflecting plates for reflecting the light in different directions respectively.

3. The lighting device according to claim 1, wherein the reflecting device has at least one reflecting plate having a plurality of reflecting surfaces for reflecting the light in different directions respectively.

4. The lighting device according to claim 2, wherein at least one of the reflecting plates has a plurality of reflecting surfaces for reflecting the light in different directions respectively.

5. The lighting device according to claim 1, wherein the reflecting device comprises a variable angle mechanism for varying a lighting angle at which the reflecting plate is directed.

6. The lighting device according to claim 2, wherein the reflecting device comprises a variable angle mechanism for varying a lighting angle at which each of the reflecting plates is directed.

7. The lighting device according to claim 3, wherein the reflecting device comprises a variable angle mechanism for varying a lighting angle at which the reflecting plate is directed.

8. The lighting device according to claim 4, wherein the reflecting device comprises a variable angle mechanism for varying a lighting angle at which each of the reflecting plates is directed.
